(19) United States
(12) Patent Application Publication
(10) Pub. No.: US 2007/0013095 A1
(43) Pub. Date: Jan. 18, 2007

(54) Optical film and production method of the same

(75) Inventor: Syouichi Sugitani, Kobe-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA OPTO, INC.

(21) Appl. No.: 11/483,613

(22) Filed: Jul. 11, 2006

(30) Foreign Application Priority Data
Jul. 15, 2005 (JP) JP2005-206680

(51) Int. Cl. B29C 41/28; B29C 41/52

(52) U.S. Cl. 264/40.1; 264/217; 264/169

(57) ABSTRACT

A method of manufacturing an optical film using a solution casting method comprising the steps of: (i) preparing an initial dope comprising a cellulose ester resin; (ii) preparing a casting dope by diluting the initial dope with a diluting solution via inline dilution, the diluting solution having a solid content lower than a solid content of the initial dope; and (iii) casting the casting dope to form a cellulose ester film, wherein (a) an average orientation angle of the slow axis is 90°±1.5° or 0°±1.5° against a film transport direction of the cellulose ester film; and (b) a fluctuation of a viscosity or a fluctuation of a density of the casting dope is controlled so that a relative standard deviation of the fluctuation of the viscosity or the fluctuation of the density of the casting dope is in the range of 0.01-1%.

This application is based on Japanese Patent Application No. 2005-206680 filed on Jul. 15, 2005, in Japanese Patent Office, the entire content of which is hereby Incorporated by reference.

### FIELD OF THE PRESENT INVENTION

The present invention relates to an optical film usable for, for example, a liquid crystal display (LCD) and a manufacturing method of the same.

### BACKGROUND OF THE PRESENT INVENTION

In recent years, it is common to employ retardation compensation film in liquid crystal display (LCD). Along with larger image screens and higher definition, quality demanded for retardation films becomes more sever. Specifically, in the retardation film exhibiting larger in-plane retardation, the demand for the accuracy in the slow axis (being the orientation axis) direction (being an orientation angle) is more severe, and it is desired that the accuracy is commonly at most angle of 1.5° over the entire area within the film but is preferably in the range of about ±0.3 to about 1.0°. Deterioration of the accuracy in the slow axis direction may result in deterioration of the contrast of a liquid crystal display.

Commonly employed as such a retardation film is a polycarbonate film having a larger intrinsic birefringent refractive index, which is uniaxially stretched in the longitudinal direction (also referred to as the film transport direction in the film production process or MD direction). However, it has been difficult to obtain a positive wavelength dispersion characteristic by employing only a single polycarbonate retardation film. Further, the slow axis of the above retardation film is in the longitudinal direction (MD direction), which is the same as the stretching direction.

In cases in which the retardation film is adhered to a polarizing film, it is necessary that the slow axis of the retardation film is directed toward the transverse direction of the polarizing film (being perpendicular in the film plane with respect to the uniaxial stretching direction of the polarizing film, also referred to as TD direction). Accordingly, when a retardation film has a slow axis direction in the longitudinal direction (MD direction) of the film, a long roll retardation film cannot be adhered to a long roll polarizing film without cutting the long roll films into sheets, which is unfavorable in view of productivity.

Alternatively, when a retardation film has a slow axis direction in the transverse direction (TD direction) of the film, the long roll retardation film can be directly adhered to the long roll polarizing film, which is quite favorable in view of productivity. Such a retardation film having a slow axis direction in the lateral direction of the film can be manufactured by a lateral stretching apparatus using a tenter.

In the lateral stretching process employing a tenter, the film is stretched in TD direction while the film is heated to a temperature suitable for stretching. However, well known is a bowing phenomenon in which a straight line in TD direction of the film drawn prior to the stretching, which represents a stretching line, is curved in the form of an arc after stretching.

When such a bowing phenomenon occurs, the orientation axis of the retardation film is aligned along the tangential direction of the arc, whereby the uniformity in the orientation angle in TD direction is lost. Since the bowing phenomenon varies depending on stretching conditions, various technologies to minimize the bowing phenomena have been disclosed.

Incidentally, in cases in which the bowing phenomenon is eliminated by working out stretching conditions (wherein the stretching line is in a straight line), since the film in the tenter process is softened by heating, the orientation angle may have distribution in the transverse direction due to a mechanical asymmetric property of the tenter. Further, when temperature distribution results across the width in the tenter, the softness of the film differs across the width to result in non-uniform stretching, whereby the orientation angle is distributed.

Further, besides the tenter stretching apparatus, there are many other factors which cause non-uniform orientation angle in the transverse direction. Generally, in the optical film manufacturing process, attention is paid so that non-uniformity in the conditions of the transport line and the heating/drying equipment, and in film thickness in the transverse direction is minimized. However, right and left mechanical uniformity in the production line is degraded over a period of time due to thermal distortion repeatedly applied to the production facilities and abrasion of sliding sections, whereby the orientation angle varies over an elapse of time.

Further, in cases in which an optical film is produced in such a manner that a film prepared employing a solution casting method is subjected to in-line stretching, the conveyed film is softened due to incorporation of residual solvent and is greatly influenced by the right and left non-uniformity of the film transport line, whereby the orientation angle of the film tends to have distribution in the transverse direction. Still further, a film which has been peeled from the support tends to have a larger optical characteristic distribution in the transverse direction due to non-uniform thickness and non-uniform drying condition in the transverse direction. Such distribution in the transverse direction is pronounced when the casting rate is increased to enhance productivity.

In the manufacturing process of a high resolution optical film, specifically a retardation film, it is essential that the distribution in the lateral direction of the above orientation angle is maintained within the desired accuracy range. In the production method of film employing a lateral stretching apparatus, a method is not substantially available which precisely controls the orientation angle in the longitudinal or transverse direction.

Conventionally, a film having an orientation angle of 0° or 90° against the film transport direction has been produced by arranging the film transportation line and the stretching apparatus to be as uniform as possible on the right and the left of to the machine center. However, mechanical accuracy tends to vary over an elapse of time. Accordingly, a precise control is required.

The film manufacturing methods using the conventional stretching machine have been disclosed in the following patent documents. In Patenr documents 1 and 2, disclosed is a technique by which the orientation angle is formed in an oblique direction to MD direction (film transport direction) as one of the methods to control the orientation angle, in the production method of optical films employing a lateral stretching apparatus, and proposed is a film manufacturing method employing a lateral direction film stretching apparatuses in which the running rate and distance of the right and left clips differ. Patent Documents 1 and 2 disclose a technique in which, by declining the orientation axis by 45° to the longitudinal direction of the film, lateral and longitudinal film strength become uniform in the lateral direction/longitudinal direction.

Further, similar optical film production methods are disclosed in Patent Documents 3-5 below. These also disclose techniques to decline the orientation axis by 10-80° with respect to the longitudinal direction.

However, as in the conventional methods disclosed in the above patent documents, variation of optical properties such as an orientation angle in TD direction tend to occur when the formation condition of a web (film) is not always constant even if the stretching condition of the web is homogenized and the machine precision is increased. Specifically, a problem has been variation of film hardness depending on the variation of residual solvent content in the film entering the tenter process.

(Patent Document 1) Japanese Patent Publication for Public Inspection (hereinafter referred to as JP-A) No. 50-83482

(Patent Document 2) JP-A No. 2-113920

(Patent Document 3) JP-A No. 3-124426

(Patent Document 4) JP-A No. 3-192701

(Patent Document 5) JP-A No. 4-164626

### SUMMARY OF THE PRESENT INVENTION

An object of the present invention is to provide an optical film suitable for a retardation film which provides an excellent contrast to a liquid crystal display, specifically to a large screen liquid crystal display, and a manufacturing method of the optical film.

One of the aspects of the present invention is a method of manufacturing an optical film using a solution casting method comprising the steps of:

(i) preparing an initial dope comprising a cellulose ester resin;

(ii) preparing a casting dope by diluting the initial dope with a diluting solution via inline dilution, the diluting solution having a solid content lower than a solid content of the initial dope; and

(iii) casting the casting dope on a metal support to form a cellulose ester film,

wherein
(a) a slow axis of the cellulose ester film is perpendicular (an average orientation angle of the slow axis is 90°±1.5°) or parallel (the average orientation angle of the slow axis is 0°±1.5°) to a film transport direction of the cellulose ester film; and
(b) a fluctuation of a viscosity or a fluctuation of a density of the casting dope is controlled so that a relative standard deviation of the fluctuation of the viscosity or the fluctuation of the density of the casting dope is in the range of 0.01-1%.

### BRIEF DESCRIPTION OF THE DRAWINGS

FIG. 1 is a flow sheet of the outline of a solution casting film forming equipment for embodying the optical film producing method of the present invention.

FIG. 2 is a flow sheet of the outline of a powder mixing system including a device for measuring the amount of the cellulose ester resin powder.

FIG. 3a shows an enlarged partial cross section of the resin powder measuring apparatus where the stopping valve is closed.

FIG. 3b shows an enlarged partial cross section of the resin powder measuring apparatus where the stopping valve is open.

FIG. 3c shows an enlarged partial cross section of the resin powder measuring apparatus where the stopping valve is incompletely closed since the valve is blocked by a lump of resin powder being caught by the valve.

FIG. 4 shows an enlarged cross section of the measuring device which describes the means for preventing the incomplete closing of the stopping valve.

### DESCRIPTION OF THE PREFERRED EMBODIMENTS

In the present invention, it was found that a liquid crystal display, specifically a large screen liquid crystal display exhibiting an excellent contrast is obtained by using an optical film of the present invention manufactured by a solution casting method in which the fluctuation of the viscosity or the density of the casting dope as well as the fluctuation of residual solvent in the stretching process are reduced.

The above object of the present invention is achieved by the following structures.

(1) A method of manufacturing an optical film using a solution casting method comprising the steps of:

(i) preparing an initial dope comprising a cellulose ester resin;

(ii) preparing a casting dope by diluting the initial dope with a diluting solution via inline dilution, the diluting solution having a solid content lower than a solid content of the initial dope; and

(iii) casting the casting dope on a metal support to form a cellulose ester film,

wherein
(a) a slow axis of the cellulose ester film is perpendicular (an average orientation angle of the slow axis is 90°±1.5°) or parallel (the average orientation angle of the slow axis is 0°±1.5°) to a film transport direction of the cellulose ester film; and
(b) a fluctuation of a viscosity or a fluctuation of a density of the casting dope is controlled so that a relative standard deviation of the fluctuation of the viscosity or the fluctuation of the density of the casting dope is in the range of 0.01-1%.
   (2) The method of Item (1), wherein an amount of the diluting solution used for the inline dilution to the initial dope is automatically controlled by measuring the viscosity or the density of the initial dope before the inline dilution, and by calculating the amount of the diluting solution so that the relative standard deviation of the fluctuation of the viscosity or the fluctuation of the density of the casting dope is in the range of 0.01-1%.
   (3) The method of Item (1), wherein

(i-a) the initial dope is prepared by dissolving a film forming material including the cellulose ester resin in a solvent in a dissolution vessel; and

(i-b) a new batch of the dissolution of the film forming material is started while an initial dope prepared in a last batch remains in the dissolution vessel in an amount of 5-50% by weight of an amount of the new batch.

(4) The method of any one of Items (1) to (3), wherein the initial dope is prepared by dissolving a cellulose ester resin powder in the solvent and an amount of the cellulose ester resin powder is weighed with an accuracy of −1 to +2% based on a predetermined amount.

(5) The method of any one of Items (1) to (4) further comprising the steps of:

(i-1) still standing the initial dope prepared in the step (i), which is referred to as a first dope standing step;

(i-2) filtering the initial dope after the first dope standing step; and

(i-3) still standing the initial dope filtered in the step (i-2), which is referred to as a second dope standing step,

wherein each of amounts of the initial dope still stood in the first standing step and the second standing step is 1 to 5 times larger than an amount of a new batch of the initial dope.

(6) An optical film manufactured by the method of any one of Items (1) to (5).

In the present invention, one of the major objects is to keep the solid content of the casting dope constant. However, the measurement of the solid content of a dope is difficult, resulting in giving a large variation, since a volatile solvent is used in the dope. Accordingly, the solid content can be relatively confirmed using a viscometer or a density meter (specifically, an inline viscometer or an inline density meter). Namely, a purpose of the present invention is to keep the solid content of the casting dope, and the viscosity and the density of the dope is used as the means to measure the solid content.

The present invention of Item (1) is a method for producing an optical film comprising the steps of preparing a dope for casting (also referred to as a casting dope) by diluting an initially prepared dope (also referred to as an initial dope) mainly comprised of a cellulose ester resin by adding a diluting liquid having a solid content lower than that of the initial dope by an inline addition, and casting the dope for producing a cellulose ester film having an optical slow axis being approximately perpendicular (the average orientation angle of the slow axis is 90°±1.5°) or parallel (the average orientation angle of the slow axis is 0°±1.5°) with the transport direction (also referred to as a longitudinal direction or MD direction) of the film, wherein a variation of viscosity or density of the casting dope after the dilution is within the range of from 0.01 to 1%. According to the present invention of Item (1), fluctuation of the solid content can be minimized by reducing the fluctuation of the viscosity or density, namely the solid content, of the dope on the occasion of the casting and reducing the fluctuation of the amount of the residual solvent in the cast film, and the dope having the fluctuation of the viscosity or the density within a certain range namely the fluctuation of the solid content within a certain range can be constantly supplied. As a result of that, the thickness variation in the lateral and longitudinal directions (the lateral direction is also referred to as the width direction or TD direction) in the resulted film can be minimized so that the fluctuation in the optical property of the film can be reduced, and a superior contrast property can be given to a liquid crystal display when the film is used as a retardation film specifically for a large screen liquid crystal display. “The average orientation angle of the slow axis” means the average value of the orientation angles of the slow axis measured at plural points in the lateral direction and in the longitudinal direction of the optical film.

The present invention of Item (2) is the method for producing the optical film described in Item (1), wherein the viscosity or the density of the initial dope mainly comprised of the cellulose ester resin is measured before the inline addition of the diluting liquid and the amount of the diluting liquid is calculated so that the standard deviation of the viscosity or the density becomes within the range of from 0.01 to 1%, and the flowing amount of the inline adding diluting liquid is automatically controlled. According to the present invention of Item (2), the flowing amount of the diluting liquid through the inline adding means is automatically controlled. Therefore, the dope having the viscosity and the density, namely the solid content within the certain range is constantly supplied on the occasion of the casting so that thickness variation of the film in the lateral and longitudinal directions becomes little. As a result of that, the optical property of the resulted film can be made small. Moreover, loss of the time can be reduced and the fluctuation can be minimized because the control is automatically performed.

The present invention of Item (3) is the method for producing the cellulose ester film described in Item (1), wherein the charging of raw materials of the film into a dissolution vessel is started in a situation in which the dope prepared at the last batch remains in the dissolution vessel in an amount of from 5 to 50% by weight of the amount of the raw materials to be charged. According to the present invention of Item (3), the fluctuation of the properties of the dope can be minimized by mixing with the dope prepared at the last batch even if there is a little variation in the charging amount of the raw materials into the vessel.

The present invention of Item (4) is the method for producing the optical film described in any one of Items (1) to (3), wherein the cellulose ester resin is powder which is charged in the process for preparing the initial dope mainly comprised of the cellulose ester resin and the accuracy of the adding amount of the cellulose ester resin is within the range of from −1% to +2% of a predetermined amount. According to the present invention of Item (4), the fluctuation in the solid content can be minimized and the dope having the viscosity or the density, namely the solid content, within the certain range can be constantly supplied because the amount of the resin powder within the certain range can be constantly supplied. As a result of that, the variation of the film thickness in the lateral and longitudinal directions can be minimized and the fluctuation in the optical property of the resultant film can be reduced. By setting the average value of the adding amount of the cellulose ester resin slightly larger than the predetermined amount, namely, by setting the percentage of the average adding amount in the plus zone, it is possible to adjust the solid content of the dope via inline addition of a diluting solution to the dope when the density or the viscosity of the dope is higher than the predetermined value, thus the variation of viscosity or density of the dope at the casting zone is minimized, because when the solid content of the initial dope is lower than the predetermined value, there in no way to adjust the solid content of the dope to the predetermined value and the fluctuation of the solid content of the dope becomes larger.

The present invention of Item (5) is the method described in any one of Items (1) to (4), wherein the method comprises the steps for preparing the initial dope mainly comprised of the cellulose ester resin by dissolving the cellulose ester resin as the raw material of the film: a first standing step for standing the dissolved dope; a step for filtering the dope after the standing, a second standing step for secondarily standing the filtered dope; a step for preparing a dope for casting by diluting the initial dope mainly comprised of the cellulose ester resin after standing by inline adding a diluting liquid having a solid content lower than that of the initial dope; and a step for forming a film by casting the dope for casting onto a metal support, in which the weight of the dope standing in the first and the second standing steps is 1 to 5 times of the weight of the dope to be newly prepared. According to the present invention of Item (5), the fluctuation of the solid content in the dope can be minimized even if the adding amount of the raw material to the dissolution vessel is varied a little because the variation is absorbed by the dope stocked in the standing steps so that the dope having the viscosity or the density, namely the solid content, within the certain range can be constantly supplied. As a result of that, the variation of the film thickness in the width and length directions can be minimized and the fluctuation in the optical property of the resultant film can be reduced.

The present invention of Item (6) is an optical film which is produced by the method described in any one of Items (1) to (5). According to the present invention of Item (6), the optical film can be provided in which the variation of the film thickness in the lateral and longitudinal directions is minimized and the fluctuation in the optical property of the resultant film is reduced.

The embodiments of the present invention are described below but the present invention is not limited to that.

In the film producing method of the present invention, an optical film of a cellulose ester resin is produced by a solution casting film forming method.

The materials to be used in the optical film producing method of the present invention include additives such as a plasticizer a UV absorbent and a matting agent besides the cellulose ester resin and a solvent.

The cellulose ester resin to be used in the present invention includes cellulose triacetate, cellulose diacetate, cellulose acetate-butylate and cellulose acetate propionate.

In the case of the cellulose triacetate, a cellulose triacetate having a polymerization degree of from 250 to 400 and a bonded acetic acid amount of from 54 to 62.5% is prepared and one having a bonded acetic acid amount of from 58 to 62.5 is more preferable because the strength of the film is higher. As the cellulose triacetate, one synthesized from cotton linter and that synthesized from wood pulp can be used solely or in combination.

The use of a major amount of the cellulose triacetate synthesized from cotton linter is preferable because such the triacetate is easily peeled off from the belt or drum and gives high producing efficiency. A ratio of the cellulose triacetate synthesized from the cotton linter of not less than 60% by weight is preferable because the peeling is considerably accelerated and a ratio of not less than 85% is more preferable and the solely use of it is most preferable.

The plasticizer preferably usable in the present invention includes a phosphate type plasticizer such as triphenyl phosphate, tricresyl phosphate, cresylphenyl phosphate, octyldiphenyl phosphate, diphenylbiphenyl phosphate, trioctyl phosphate and tributyl phosphate, a phthalate type plasticizer such as diethyl phthalate, dimethoxyethyl phthalate, dimethyl phthalate, dioctyl phthalate, dibutyl phthalate and di-2-ethylhexyl phthalate, a glycolate type plasticizer such as triacetine, triptine, butylphthalylbutyl glycolate, ethylphthalylethyl glycolate, methylphthalylethyl glycolate and butylphthalylbutyl glycolate, though the plasticizer is not specifically limited.

Two or more kinds of these plasticizers may be used in combination according to necessity. In such the case, it is preferable to make the using ratio of the phosphate type plasticizer to not more than 50% because the hydrolysis of the cellulose ester resin is inhibited and the durability of the film is raised by such the using ratio.

A smaller ratio of the phosphate type plasticizer is more preferable and the singly use of the phthalate type or the glycolate type plasticizer is particularly preferable.

In the present invention, a preferable adding amount of the plasticizer suitable for making the water absorption or the moisture content of from 3 to 30%, more preferably from 10 to 25%, and further preferably from 15 to 25%, by weight of the cellulose ester resin. An adding amount of the plasticizer exceeding 30% by weight is not preferable because deterioration in the mechanical strength and the dimension stability of the cellulose ester resin film is caused.

In the present invention, it is preferable to add an UV absorbent to the cellulose ester resin film. As the UV absorbent, one is preferred in which the absorption ability to UV rays of 370 nm or less is excellent for inhibiting the deterioration of the liquid crystal and the absorption to visible rays of not less than 400 nm is as low as possible for obtaining the good displaying ability of the liquid crystal.

In the present invention, a UV ray transparency at 370 nm of not more than 10% is necessary, and the transparency is preferably not more than 5% and more preferably not more than 2%.

In the present invention, usable UV absorbents include an oxybenzophenone type compound, a benzotriazole type compound, a salicylate type compound, a benzophenone type compound, a cyanoacrylate type compound and a nickel complex compound though the UV absorbent is not limited to them.

In the present invention, it is preferable to use one or more UV absorbents, and two or more kinds of the UV absorbent different from each other may be contained.

The UV absorbent preferably used in the present invention is the benzotriazole type and the benzophenone type UV absorbents. An embodiment is particularly preferred, in which the benzotriazole type UV absorbent is added to the cellulose ester resin film; the benzotriazole type UV absorbent causes less unnecessary coloring.

The UV absorbent may be added to the dope in a state of a solution dissolved in an organic solvent such as alcohol, methylene chloride and dioxoran or directly to the composition of the dope. A material insoluble in an organic solvent such as an inorganic particle is added to the dope in a state of dispersion prepared by dispersing by a dissolver or a sand mil into a solution of the cellulose ester resin in an organic solvent.

An adding amount of the UV absorbent in the present invention is from 0.1 to 2.5%, preferably from 0.5 to 2.0%, and more preferably from 0.8 to 2.0%, by weight of the cellulose ester resin. An adding amount exceeding 2.5% by weight is undesirable since the transparence of the cellulose ester resin film tends to be lowered.

A particle may be added as a matting agent to the cellulose ester resin film for preventing sticking between the films and giving slipping ability so as to give an easiness of handling to the film.

The particle either may be an inorganic compound or an organic compound. Examples of the inorganic particle include fine a particle of silicon dioxide, titanium dioxide, aluminum oxide, zirconium oxide and tin oxide. Among them, a compound containing a silicon atom is preferable and silicon dioxide particle is preferable. Examples of the silicon dioxide particle include Aerosil 200, 200V, 300, R972, R972V, R974, R976, R976S, R202, R812, R805, OX50, TT600, RY50, NY50, NAX50, NA50H, NA50Y, NX90, RY200S, RY200, RX200, R8200, RA200H, RA200HS, NA200Y, R816, R104, RY300, RX 300 and R106. Among them, Aerosil 200V and R972V are preferable from the viewpoint of controlling the dispersing state and the particle diameter.

The average particle diameter of the particle in the film is preferably from 50 nm to 2 μm, more preferably from 100 nm to 1,000 nm, and further preferably from 100 nm to 500 nm, from the viewpoint of holding the slipping ability and the high transparency. The average particle diameter of the particles in the film can be confirmed by observing a photograph of the cross section of the film.

In the case of the particle, the primary particle diameter, the particle diameter after dispersed in the solvent and the particle diameter after added into the film are frequently different; it is important to control the diameter of the finally formed coagulated particle by combining the particles with the cellulose ester resin.

An adding amount of the particle is from 0.02 to 0.5%, and preferably from 0.04 to 0.3%, by weight of the cellulose ester resin film.

The dispersing of the particles is carried out by treating a mixture of the particles and the solvent by a high pressure dispersing apparatus. As the high pressure dispersing apparatus, a high pressure dispersing apparatus can be applied, by which a specific condition such as high shearing force and high pressure can be formed by passing the mixture of the particles and the solvent through a thin pipe at a high rate. In the high pressure dispersing apparatus, the maximum pressure is preferably not less than 100 kgf/cm², more preferably not less than 200 kgf/cm², in a thin pipe having a diameter of from 1 to 2,000 μm. The apparatus capable of reaching the maximum rate to 100 m/sec or more and a thermal transmission of 100 kcal/hr is preferable. Example of the high pressure dispersing apparatus includes an ultra high speed homogenizer (commercial name: Microfluidizer) manufactured by Microfluidics Corporation and Nanomizer manufactured by Nanomizer Nanomizer Co., Ltd. Other than the above, Manton-Goulin type high pressure dispersing apparatus such as a homogenizer manufactured by Izumi Food Machinery Co., Ltd is applicable.

The particles to be used in the present invention are dispersed in a solution containing 25 to 100% by weight of a water soluble solvent and the resultant dispersion is diluted by 0.5 to 1.5 times of the water soluble solvent of a water insoluble solvent and then mixed with the dope composed of the cellulose ester resin dissolved in a solvent. The mixture was cast onto the support and dried to obtain the cellulose ester resin film.

A lower alcohol is mainly used for the water soluble solvent. Preferable examples of the lower alcohol are methyl alcohol, ethyl alcohol, propyl alcohol, isopropyl alcohol and butyl alcohol.

Though the water insoluble solvent to be used in the present invention is not specifically limited, a solvent to be used on the occasion of forming the film of the cellulose ester resin is preferably used, and one having a water solubility of not more than 30% by weight is used. Examples of such the water insoluble solvent include methylene chloride, chloroform and methyl acetate.

The particles are dispersed in the solvent in a concentration of from 1 to 30% by weight. The concentration higher than the above is not preferable since the dispersing carried out at a concentration higher than the above causes considerable increasing in the viscosity. The concentration of the particle in the dispersion liquid is preferably from 5 to 25%, and more preferably from 10 to 20%, by weight.

The haze of the cellulose ester resin film can be measured according to ASTM-D1003-52, for example. The haze is preferably from 0 to 0.6%, more preferably from 0 to 0.4%, and further preferably from 0.1 to 0.2%.

In the present invention, a lower alcohol such as methanol, ethanol, n-propyl alcohol, iso-propyl alcohol and n-butanol, a cyclohexanedioxan, and an aliphatic hydrocarbon chloride such as methylene chloride are usable for the solvent of the cellulose ester resin.

A preferable example of the solvent ratio is 70 to 95% by weight of methylene chloride and 30 to 5% by weight of another solvent. The concentration of the cellulose ester resin in the dope is preferably from 10 to 50% by weight. The heating temperature after the addition of the solvent is preferably a temperature higher than the boiling point of the solvent and being within the range in which the solvent is not boiled. The temperature is set at a temperature of not less than 60° C., for example, preferably within the range of from 80 to 110° C. The pressure is set so that the solvent is not boiled.

After dissolving, the cellulose ester resin dope is take out for the vessel or extracted by a pump while cooling and cooled by a heat exchanger. The resultant dope is supplied for forming the film.

Regarding general matters relating to the optical film production by the solution casting method, the method described in the following documents can be referred; U.S. Pat. Nos. 2,492,978, 2,739,707, 2,739,069, 2,492,977, 2,336,310, 2,357,603 and 2607704, Brit. P. Nos. 64,071 and 735,892, and JP-A Nos. 45-9074, 49-4554, 49-5614, 60-27562, 61-39890 and 62-4208.

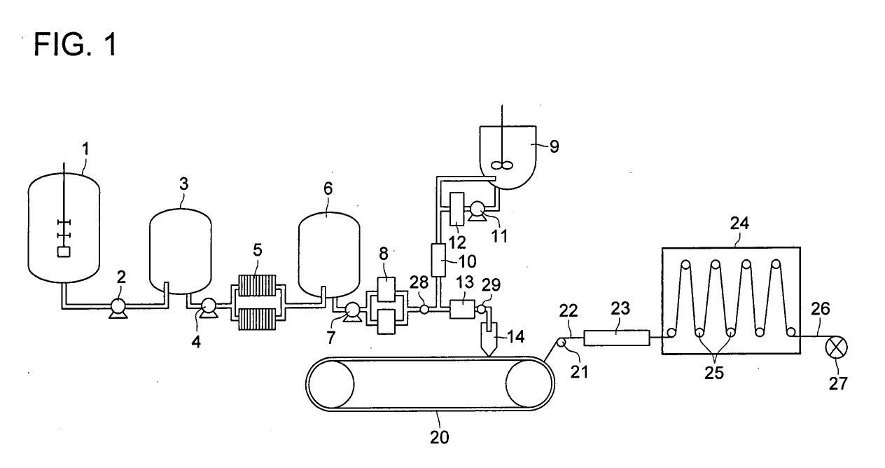

FIG. 1 schematically shows a dope preparation process, a casting process, a drying process and a winding up process of a solution casting film forming equipment relating to the film producing method of the present invention. The example shown here is only an example of the solution casting film forming method and the embodiment of the present invention is not limited to the processes shown in FIG. 1.

In the production method of the dope containing the cellulose derivative shown in FIG. 1, the cellulose ester resin is dissolved in a dissolution vessel 1 by the organic solvent mainly composed of a good solvent for the cellulose ester resin while stirring to prepare a dope.

For dissolving the cellulose ester resin, various methods such as a method carried out under ordinal pressure, a method carried out at a temperature higher than the boiling point of the solvent while applying high pressure, a cooling dissolving method described in JP-A Nos. 9-95544, 9-95557 and 9-95538 and a method carried out at high pressure described in JP-A No. 11-21379 can be applied; among them the method carried out at a temperature higher than the boiling point of the main solvent while applying high pressure is preferable.

The temperature after adding the solvent is set at a temperature of, for example, not less than 60° C., preferably within the range of from 80 to 110° C. The pressure is set so that the solvent is not boiled. The concentration of the cellulose ester resin in the dope is preferably from 10 to 35% by weight.

Necessary additives such as the plasticizer, UV absorbent and matting agent other than the cellulose ester resin and the solvent may be preliminary dissolved or dispersed and added to the solvent to be used for dissolving the cellulose ester resin or to the dope of the dissolved cellulose ester resin.

The kind of the dissolution vessel 1 (pressure vessel) is not specifically limited as long as the vessel is endurable to the designated pressure and the content of the vessel can be heated and stirred under the pressure in the vessel. Meters such as a pressure gage and a thermometer are optionally attached to the pressure vessel. The pressure may be applied by introducing high pressure inactive gas such as nitrogen gas or by rising solvent vapor pressure accompanied with heating. The heating is preferably given from outside the vessel. For example, a jacket type vessel is preferable since the temperature can be easily controlled.

In the optical film producing method of the present invention, the initial dope mainly comprised of the cellulose ester resin prepared in the dissolution vessel (pressure vessel) is diluted by inline addition of the diluting liquid having a solid content lower than that of the initial dope to prepare the casting dope, and the cellulose ester resin film which is formed by the solution casting method by using the casting dope has the optical slow axis being perpendicular (the average orientation angle of the slow axis is 90°±1.5°) or parallel (the average orientation angle of the slow axis is 0°±1.5°) to the film transport direction. In the present invention, variation of the viscosity or the density of the casting dope after the dilution is within the range of from 0.01 to 1% by relative standard deviation.

In concrete, particle dispersion (particle adding liquid) is prepared in another vessel by mixing the particles and the solvent by a high pressure dispersing apparatus and the resultant particle dispersion is introduced into the dissolution vessel 1 for adding to the cellulose ester resin solution (dope) on the occasion of the dissolution. In another case, the whole or a part of the additives such as the plasticizer is added to the dope.

The initial dope is sent to a first dope standing vessel 3 as a vessel for stocking the dope through a liquid sending pump 2 and once stocked in the first dope standing vessel. After the standing, the initial dope is primarily filtering by introducing to a primary filtering apparatus 5 through a liquid sending pump 4 for removing coagula. In the primary filtering apparatus 5, the initial dope after standing is filtered by a filter such as filter paper or sintered metal filter. After that, the dope is stocked in a second dope standing vessel 6.

After the standing, the initial dope is introduced by a liquid sending pump 7 to a secondary filtering apparatus 8 and secondarily filtered. In the secondary filtering apparatus 8, the initial dope is filtered by a filter such as filter paper or sintered metal filter.

In the above processes, the temperature and the holding time at this temperature on the occasion of the dissolution in the dope dissolution vessel 1, the temperature in the first dope standing vessel 3 and the second standing vessel 6 and the holding time at this temperature are individually controlled.

On the other hand, a UV absorbent adding solution prepared in an additive dissolution vessel 9 is introduced by a liquid sending pump 11 to a circulation filter 12 and filtered with circulation, and apart of the UV absorbent adding solution is filtered by an inline adding liquid filter 10. The UV absorbent adding solution corresponds to the diluting liquid having a solid content lower than that of the initial dope in the method of the present invention.

In the present invention, the initial dope mainly comprised of the cellulose ester resin prepared in the dissolution vessel 1 (pressure vessel) and secondarily filtered is introduced into a static mixer 13. In this occasion, the diluting liquid having a solid content lower than that of the initial dope, namely the UV absorbent adding solution, is inline added at a position before the static mixer 13 for diluting the initial dope to prepare the casting dope. The casting dope is introduced into a casting die 14 and the cellulose ester resin film is formed by the solution casting method.

According to the present invention, the optical slow axis of the optical film mainly comprised of the cellulose ester resin film is perpendicular (the average orientation angle of the slow axis is 90°±1.5°) or parallel (the average orientation angle of the slow axis is 0°±1.5°) to the film transport direction.

In the optical film producing method of the present invention, the fluctuation of the viscosity or the density of the diluted casting dope is within the range of from 0.01 to 1% by the relative standard deviation.

A relative standard deviation of the viscosity of the casting dope of less that 0.01% is not preferable since excessively high cost is required for raising the accuracy of the flowing rate of addition of the diluting liquid even though such the deviation is suitable for reducing the variation of the concentration of the solid component. A relative standard deviation of the viscosity of the casting dope of more than 1% is also not preferable since the fluctuation in the film thickness is increased on the occasion of the casting so that the fluctuation in the optical properties, particularly orientation angle, of the film is increased.

In the case of the fluctuation in the density of the casting dope is the same as the case of the above-mentioned fluctuation in the viscosity of the casting dope.

In the optical film producing method of the present invention, the cellulose ester resin is in a state of powder at the time of charging in the dissolving process and the measuring accuracy of the charging amount is within the range of from −1% to +2% of the predetermined amount. Namely, it is necessary to make the measuring accuracy to within the range of from −1% to +2% of the predetermined amount on the occasion of charging the resin powder into the pressure vessel in which the resin powder is dissolved.

When the measuring accuracy of the amount of the resin powder is without the range of from −1% to +2%, the fluctuation in the residual solvent amount on the occasion of the film formation is increased because the difference of the solid content between each of the dissolving batch is increased. As a result of that, the variation in the optical properties is increased so that the preposition of the present invention of that the optical slow axis of the optical film mainly comprised of the cellulose ester resin film is perpendicular (the average orientation angle of the slow axis is 90°±1.5°) or parallel (the average orientation angle of the slow axis is 0°±1.5°) to the film transport direction cannot be satisfied and the contrast of the liquid crystal display is undesirably lowered.

Improvement in the measuring accuracy of the resin powder is generally attained by improvement of the property of the powder or by improvement of the measuring instrument, examples of which will be shown below, however, the present invention is not limited thereto.

The measuring accuracy can be improved by improving the property of the powder. For example, the compressibility (density in compressed state/density in non-compressed state) of the powder can be lowered by making granules having high compressibility for improving the fluidity of the powder. In such the case, however, there is a suitable range in the compressibility because the powder is leaked through the stopping valve of the measuring apparatus before the measuring when the compressibility of the powder is excessively lowered and the fluidity is excessively raised.

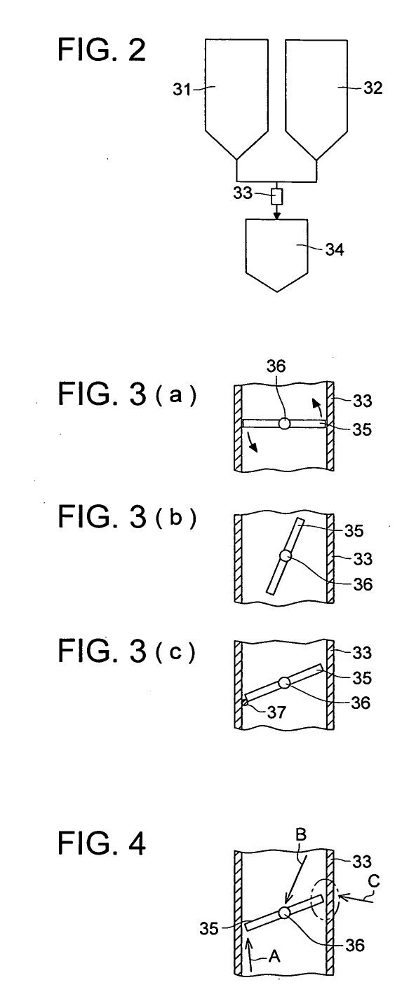

FIG. 2 is a flow sheet showing an outline of a powder mixing system including a measuring apparatus for the cellulose ester resin powder. In the flow sheet, the powders are each put into the measuring apparatus 33 from a silo 31 stocking cellulose ester resin powder and a silo 32 stocking crashed powder (recycled material) of cellulose ester resin film, respectively, and weighed and then the mixture of the resin powder and the crashed film powder is once stocked in a stocking silo 34.

In the optical film producing method of the present invention, it is preferable that the raw material of the resin film contains the recycled material. The recycled material of the resin film is a material prepared by crushing the film formed from the raw materials of the resin film for reusing as the raw material of the film.

In the optical film producing method of the present invention, the ratio of the recycled material contained in the raw materials of the resin film is preferably from 0 to 50%, particularly from 5 to 45%.

FIG. 3 shows an enlarged partial cross section of the resin powder measuring apparatus. FIG. 3(a) shows a closed state of a stopping valve 35 which is rotatable by an axis 36. FIG. 3(b) shows an opened state of the stopping valve. FIG. 3(c) shows an incompletely closed state of the stopping valve in the reason of that the valve is blocked by a lump of resin powder 37 caught by the valve.

When the powder is put into the measuring apparatus 33 for measuring, measuring error is caused by slightly leaking of the powder from the silos 31 and 32 if the lump of resin powder or the lump of the crushed film (recycled material) 37 blocks the rotatable stopping valve 35 so that the valve 35 cannot be completely closed as shown in FIG. 3c.

FIG. 4 shows an enlarged partial cross section of the measuring apparatus 33. As a measure for improving the measuring accuracy by preventing the incomplete closing of the stopping valve, for example, (A) a method for removing the lump 37 by blowing compressed air or electrically discharging air, (B) a method for strongly closing the stopping valve 33 by raising the closing force applying to the valve, and (C) a method by using a material which tends not to block any material such as Teflon® for the material of the rotatable stopping valve 35 are applicable. One of the most effective methods to improve the measuring accuracy is that (i) one batch of the cellulose ester powder for dissolution is stored in an intermediate hopper in which the weight of the powder is measured using a load cell; and (ii) when the measured weight is smaller than the desired weight, the cellulose ester powder is added and when the measured weight is larger, the cellulose ester powder is partially returned to the stock silo. The weight of the cellulose ester powder stored in the intermediate hopper is preferably controlled automatically using data obtained by the load cell via computation. Since, in this method, the measuring accuracy is controllable within ±0.5%, the average adding amount of the cellulose ester can be set in a plus zone of 0-0.5%.

In the optical film producing method of the present invention, the viscosity of the initial dope is measured before the addition of the diluting liquid and then diluted by the diluting liquid by the inline addition. On this occasion, the flowing amount of the diluting liquid for the inline addition is automatically controlled by calculation according to the measured value so that the standard deviation of the viscosity is adjusted into the range of from 0.01 to 1%.

The viscosities of the dope before and after the inline dilution are preferably monitored using inline sensors inserted inside the pipe. More specifically, in the pipe before and after the inline dilution, namely, 28 and 29 in FIG. 1, the viscosities are measured by the inserted sensors under a stream of 0.01 m/sec or more. Each sensor is installed in the pipe where the dope flows upward. The viscosities are measured using Viscomate FVM-80A produced by CBC Co., Ltd. The measured data are converted to the viscosity data at 35° C. and recorded as trend data showing variation with time while sampling in every second.

The densities of the dope before and after the inline dilution, namely, 28 and 29 in FIG. 1, are also preferably monitored using inline sensors inserted inside the pipe. The densities are measured using FDM-50A produced by CBC Co., Ltd. As the same as the viscosities, the measured density data are converted to those at 35° C. and recorded as trend data showing variation with time while sampling in every second.

As above-described, the viscosity or the density of the dope is measured and the liquid having a solid content lower than that of the dope is added so that the relative standard deviation of the measured value to the averaged value is made into the range of from 0.01 to 1% for constantly holding the solid content of the dope.

The inline adding liquid may be a solution composed of additives to be added to the dope and a solvent the same as the solvent of the dope, and the liquid further containing the resin the same as that of the dope, or a solvent the same as that in the dope only.

The solid content in the inline adding liquid is preferably from 10 to 50% of that in the dope. The content of less than 10% is not preferable since the difference between the dope and the inline adding liquid is excessively large so that the mixing tends to be insufficient. The content of more than 50% is also not preferable since a large amount of the liquid is required for obtaining desired dilution effect so that the flow rate controlling becomes difficult and a large producing apparatus accompanied with high cost is required.

The mixing of the dope and the inline adding liquid can be performed by a usual method, and the use of a static mixer is preferable from the viewpoint of uniformity of the viscosity.

In the optical film producing method of the present invention, in the process for dissolving the cellulose ester resin as the raw materials of film to prepare the initial dope mainly comprised of the cellulose ester resin, the charge of the raw material of the film such as cellulose ester resin is started in a state of that the dope prepared in last batch is remaining in the dissolution vessel in an amount of from 5 to 50% by weight of the dope to be newly charged.

In the present invention, the charge of the raw materials is started in a state of that the dope dissolved at the last batch is remained in the dissolution vessel in an amount of from 5 to 50% of the total amount of one batch to be charged before the charging of the resin, additives and solvent to the dissolution vessel in the process for preparing the initial dope mainly comprised of the cellulose ester resin. The remaining amount of the dope dissolved at the last time of less than 5% is not preferable since influence of the measuring error of the amount of the resin or the solvent easily appears and causes variation of the solid content in the dope. The remaining amount of the dope dissolved at the last time of more than 50% is not realistic since the capacity and the stirring power should be made larger and high cost is required.

In the present invention, the optical film producing method by the solution casting method comprises a step for preparing the initial dope mainly comprised of the cellulose ester resin by dissolving the cellulose ester resin as the raw material of the film; a first standing step for standing the dissolved dope; a step for filtering the dope after the standing, a second standing step for secondarily standing the filtered dope; a step for preparing a casting dope by diluting the initial dope mainly comprised of the cellulose ester resin after standing by inline adding a diluting liquid having a lower solid content lower than that of the initial dope; and a step for forming a film by casting the casting dope onto a metal support in which the weight of the dope standing in the first and the second standing steps is 1 to 5 times of the weight of newly prepared dope.

In the present invention, the fluctuation of the solid content of the dope can be reduced by providing the dope standing vessel in the course of from the dissolution vessel to the casting and making the amount of the dope standing in the standing vessel to 1 to 5 times of the whole amount of one batch in the dissolution vessel. The amount of the dope remaining in the dissolution vessel of less than 1 time of the whole weight of one batch to be charged into the dissolution vessel is not preferable since the effect of the remaining dope is not obtained and the fluctuation in the solid content occurs. When the amount of the remaining dope exceeds 5 times of the whole weight of the one batch to be charged into the dissolution vessel, the apparatus should be made large and high cost is required. Moreover, coagulation of the additive and precipitation of the particles are caused, which cause formation of foreign matters on the film because the staying time of the dope becomes excessively long.

A little number of foreign matter in the cellulose ester resin film is preferred. The foreign matter includes one detectable by polarized light in crossed nicols state and one formed by coagulum of particles projecting from the film surface.

The foreign matter detectable by polarized light in crossed nicols state is one observed by setting the cellulose ester resin film between two polarization plates arranged in a crossed state at right angle (crossed nicols state). Such the foreign matters are observed as brightening point in the field of the crossed nicols polarization state and the number and the size of it can be easily detected.

The cellulose ester resin film reduced in the presence of the foreign matter can be obtained by filtering the dope composition comprising the cellulose ester resin and the solvent by the following filter paper, though the means is not specifically limited. In such the case, it is preferable that the film is cast after filtering the dope by filter paper having a water filtering time of not less than 20 seconds while applying a pressure of not more than 16 kg/cm². It is more preferable that the water filtering time is not less than 30 seconds and the pressure is not more than 12 kg/cm², and further preferable that the water filtering time of the filter paper is not less than 40 seconds and the pressure if not more than 10 kg/cm². The filter paper is preferably piled two or more sheets. The filtering pressure can be controlled by suitably selecting the flow rate and the filtering area.

As is shown in FIG. 1, the casting dope which is prepared by inline adding the diluting liquid having a solid content less than that of the initial dope or the UV absorbent adding liquid to the initial dope, is cast onto a support 20 through a casting die 14.

As the casting die 14, a pressure die is preferable which is capable of controlling the shape of the slit of the mouth of die so that the film thickness can be easily uniformed. The pressure die include a coat hanger die and a T-die, and both of them are preferably usable. As the support 20 in the casting process, a mirror faced stainless steel rotatable belt or drum is used. Though the casting can be carried out at a support temperature of from 0° C. to less than the boiling point of the solvent, the casting on the support 20 at a temperature of from 5 to 30° C. is preferable because the limitation time for peeling by gelling can be shortened, and the casting at a temperature of from 5 to 15° C. is more preferable. The peeling limit time is the time for presence of cast dope on the support 20 at the limiting rate for continuously obtaining the film having high clarity and flatness. A shorter peeling limit time is preferable since high production efficiency can be obtained.

In the process of drying on the support 20, it is preferable that the cast dope is once gelled and the temperature of the dope is made to a temperature of from 40 to 70° C., more preferably from 55 to 70° C., within a time of not more than 30% of the time necessary from the casting to the peeling for accelerating evaporation of the solvent since the dope can be peeled off as fast as possible and the strength of the dope film can be increased. Moreover, such the temperature is preferably maintained for a time of 20%, more preferably 40%.

It is preferable to peel off the film from the support 20 by a peeling roller 21 at a state of that the remaining amount of the solvent is within the range of from 60 to 150%, more preferably from 80 to 120%, for reducing the peeling force from the support 20. The temperature of the dope on the occasion of peeling off is preferably from 0 to 30° C., and more preferably from 5 to 20° C., for raising the strength of the film at the time of peeling and preventing the breaking of the film at the peeling.

In the production of the cellulose ester resin film by the solution casting method, the amount of residual solvent is expressed by the following expression.
Residual solvent amount(weight−%)={(M−N)/N}×100

In the above, M is the weight of the web or film at an optional time point and N is the weight of the same film after a thermal treatment at 115° C. for 1 hour.

In the film drying process, the film peeled off from the support 20 by the peeling roller 21 is further dried so that the residual solvent amount is reduced to not more than 3%, preferably not more than 1%, and further preferably not more than 0.5%, by weight for obtaining the film having high dimensional stability.

After the peeling, the web 22 is passed through a tenter apparatus 23 in which the web is conveyed while holding the both edged thereof by clips or pins and/or a drying apparatus 24 in which the web is alternatively passed on conveying rollers arranged in the apparatus for drying. For the parts of the liquid crystal display, the drying while holding the width of the film by the tenter system is preferable for raising the dimensional stability. Particularly, it is preferable to hold the width at the point where the residual solvent amount is high, namely just after the peeling, for enhancing the dimensional stability improving effect.

The web 22 tends to be shrunk in the width direction by evaporation of solvent in the drying process after pooled of from the support 20. The shrinking is increased accompanied with rising in the drying temperature. It is preferable to inhibit the shrinking as small as possible for improving the flatness of the finished film. From such the viewpoint, the tenter method, namely the method disclosed in JP-A No. 62-46625 in which the whole or a part of the drying process is carried out while holding at the both edges of the web 22 by the clips is preferable.

Means for drying the film is not specifically limited and usually hot air, infrared rays, a heating roller and microwave are applied. The hot air is preferred from the viewpoint of simplicity. It is preferable that the drying temperature is gradually raised by three to five steps within the range of from 40 to 150° C., and the range of from 80 to 140° C. is more preferable for improving the dimensionally stability.

The processes of from the casting to the drying either may be carried out under an atmosphere of air or inactive gas such as nitrogen. Of course, the drying should be carried out considering the explosion limit concentration of the solvent gas in the atmosphere.

The cellulose ester resin film is wound up by a winder 27 into a rolled state when the residual solvent amount in the dried film 26 becomes to not more than 2% by weight. The film having good dimensional stability can be obtained by making the residual solvent amount to not more than 0.4% by weight.

The winder 27 may be usually used one, and the winding can be performed by known method such as a constant tension method, a constant torque method, a taper tension method and a programmed tension method for maintaining constant interior stress.

A knurling treatment may be applied to the both edge portions of the width direction of the cellulose ester resin film for making embossment so as to increase the apparent volume at the edge portions of the film. The winding up process can be stabilized by the knurling treatment.

A ratio X or A/D in percent of the height of the knurling A in μm to the film thickness D in μm of from 0 to 25% is preferable for stabilizing the winding.

The ratio is preferably from 0 to 15%, and more preferably from 0 to 10%. When the ratio of knurling height is larger than such the range, deformation in the shape of the wound roll tens to occur, and when the ratio is smaller than the above range, the suitability of the film for winding up is deteriorated.

In the present invention, the thickness of the cellulose ester resin film is usually from 20 to 200 μm, and is preferably fro 20 to 65 μm, more preferably from 30 to 60 μm, and further preferably from 35 to 50 μm, for satisfying demands for reducing the thickness and weight of the polarization plate to be used for the liquid crystal display (LCD). When the film is thinner than the above range, a trouble such as occurrence of winkles in the polarization plate producing process tends to be caused since the toughness of the film is lowered, and when the thickness is thicker than the above range, contribution on the thickness reduction of the LCD is small.

### EXAMPLES

Examples of the present invention are described below but the present invention is not limited thereto.

### Examples 1 Through 8

### Preparation of Dope

Cellulose Acetate Propionate (Acetyl Substitution Degree:

| | | |
|---|---|---|
| 1.9, propionyl substitution degree: | 100 | parts by weight |
| 0.8, Mn = 70,000, Mw = | | |
| 220,000, Mw/Mn = 3.14) | | |
| Triphenyl phosphate | 8 | parts by weight |
| Ethylphthalylethyl glycolate | 2 | parts by weight |
| Methylene chloride | 300 | parts by weight |
| Ethanol | 60 | parts by weight |

The above materials were put into a dissolution vessel 1 shown in FIG. 1 and completely dissolved while heating and stirring. The resultant dope was sent and stored in a first dope standing vessel 3 as a dope stocking vessel through a liquid sensing pump 2.

In the above example, the cellulose acetate propionate resin to be charged into the dissolution vessel 1 is powder and the measuring accuracy of the resin powder was within the range of from −1% to +2% as shown in Table 1. The measuring accuracy was within the range of the present invention.

On the occasion of beginning the charge of the materials of the film such as the cellulose acetate propionate, additives and solvents, the dope dissolved at the last time remains in the dissolution vessel 1 in an amount of from 5 to 50% of that of the dope to be prepared at this time according to the present invention.

The dope stood in the dope standing vessel was introduced by a liquid sensing pump 4 to a primary filtering apparatus 5 and filtered through Azumi Filter Paper No. 24, manufactured by Azumi Roshi Co., Ltd., to prepare an initial dope. The resultant initial dope was sent to a second dope standing vessel 6 and stored. After the storing, the dope was introduced to a filtering apparatus 8 by a liquid sensing pump 7 and filtered through Finemet NF, manufactured by Nihon Seisen Co., Ltd. The solid content of thus obtained main dope was 23%.

The sum of the storing amounts of the dope in the first dope standing vessel 3 and the second dope standing vessel 6 in the course of from the dissolution vessel 1 to the casting are listed in Table 1. In these examples, as is shown in FIG. 1, the amount of the dope stood in the dope standing vessels was within the range of from 1 to 5 times of that of the dope to be prepared at this time according to the present invention.

(Silicon Dioxide Dispersion)

| | |
|---|---|
| Aerogil 972V (Nihon Aerogil Co., Ltd.) | 10 parts by weight |
| (Silicon dioxide powder, primary | |
| particle average diameter: 16 nm, | |
| apparent specific gravity: 90 g/l) | |
| Ethanol | 75 parts by weight |

The above materials were mixed for 30 minutes in a dissolver and dispersed by Manton-Goulin dispersing machine. The turbidity of the dispersion was 200 ppm. To the resultant silicon dioxide dispersion, 75 parts by weight of methylene chloride was added while stirring and mixed by the dissolver for 30 minutes to prepare a silicon dioxide dispersion-containing diluting liquid.

(Preparation of Inline-Adding Liquid A)

| | | |
|---|---|---|
| Methylene chloride | 100 | parts by weight |
| Tinubin 109 (Ciba Specialty Chemicals Inc.) | 4 | parts by weight |
| Tinubin 171 (Ciba Specialty Chemicals Inc.) | 4 | parts by weight |
| Tinubin 326 (Ciba Specialty Chemicals Inc.) | 2 | parts by weight |

The above materials, namely the solvent (methylene chloride and the three kinds of UV absorbent, were put into a tightly sealed vessel 9 and completely dissolved while heating and stirring.

To the resultant solution, 20 parts by weight of the above-prepared silicon diluting liquid containing dioxide dispersion was added and further stirred for 30 minutes, and then 5 parts by weight of cellulose acetate propionate (acetyl substitution degree: 1.9, propionyl substitution degree: 0.8) was added while stirring and further stirred for 60 minutes. After that, the resultant UV absorbent adding liquid was introduced by a liquid sending pump 11 to an inline-adding liquid circulation filtering apparatus 12 and filtered through Polypropylene Wound Cartridge Filter TCW-PPS-1N, manufactured by Advantec Toyo Co., Ltd., to prepare Inline-adding liquid A. A part of Inline-adding liquid A was introduced into an inline-adding liquid sending filtering apparatus 10 and filtered through Finemet NF, manufactured by Nihon Seisen Co., Ltd. The solid content of thus obtained Inline-adding liquid A was 12%.

The initial dope after the standing and filtration as the main dope having a solid content of 23% was introduced into an inline mixer 13, a static pipe mixer Hi-Mixer SWJ manufactured by Toray Industries Inc. At the same time, 4 parts by weight of the foregoing Inline-adding liquid A having a solid content of 12% was added to 100 parts by weight of the initial dope at a point before the static mixer 13 and sufficiently mixed. Thus a casting dope is prepared by diluting the initial dope by Inline-adding liquid A having the solid content lower than that in the initial dope.

In Examples 1 through 8, the fluctuation of viscosity (fluctuation of the viscosity of the dope just before the casting) of each of the casting dopes was within the range of from 0.01 to 1% in relative standard deviation.

Next, the casting dope was uniformly cast on the stain less steel endless belt support 20 through a casting die 14 at 35° C. and in a width of 1,800 mm. On the support 20, the solvents in the dope are evaporated until the amount of the residual solvents becomes 100%, and then the dope was peeled off from the support 20 by the peeling roller 21. The solvents in the peeled web of the cellulose acetate propionate dope were evaporated at 55° C. and the web is slit into a width of 1650 mm, and then the web is stretched by a tenter 23 into 1.3 times at 130° C. in the TD direction (the direction crossing at a right angle with the transport direction of the web). The remaining amount of the solvents in the web 22 on the occasion of beginning the stretching by the tenter 23 was 18%. After that, the web was finally dried by conveying through a dying zone 24 kept at 120° C. to 110° C. by many conveying rollers 25 and slit into a width of 1,400 mm, and subjected to knurling treatment for forming knurls of a width of 15 mm and a height of 210 μm at the both edge portions of the film. The film was wound up on the winding core of a winding machine 27. Thus cellulose acetate propionate film 26 was obtained. The residual solvent amount in the cellulose acetate propionate film 26 was 0.1% and the thickness and the length of the film were each 80 μm and 4,000 m, respectively.

### Example 9

Inline-adding liquid A of Example 1 was put into the dope dissolution vessel 1 in the same ratio as that in Example 1. Besides, Inline-adding liquid B was prepared as follows and the adding flow rate was controlled so that the relative standard deviation of the density of the dope is within the range of ±2% of the averaged value. A cellulose acetate propionate film was prepared in the same manner as in Example 1 except the above-mentioned.

The condition was set so that Inline-adding liquid B should be added and the standard solid content was obtained when 5 parts by weight of Inline-adding liquid B was added to 100 parts by weight of the dope.

The standard solid content is a basic solid content of the dope for calculating the flowing rate of the dope and the standard condition (theoretical condition according to calculation) running rate of the belt support for obtaining the objective film thickness, 80 μm in this example.

In Example 9, the fluctuation of viscosity (fluctuation of viscosity just before the casting) of the dope after dilution was 0.28% in the relative standard deviation which was within the range of the present invention.

(Inline-adding liquid B)

| | | |
|---|---|---|
| Dope of Example 1 | 100 | parts by weight |
| Methylene chloride | 100 | parts by weight |
| Ethanol | 20 | parts by weight |

### Example 10

A cellulose acetate propionate film was prepared in the same manner as in Example 9 except that Inline-adding liquid B was replace with the following Inline-adding liquid C.

The condition was set so that Inline-adding liquid C should be added and the standard solid content was obtained when 5 parts by weight of Inline-adding liquid C was added to 100 parts by weight of the dope.

The difference of the solid content of the dope after addition of the inline-adding liquid from those in Examples 1 through 10 was compensated by controlling the casting flow rate so that the film thickness was the same as that in the other examples, and the difference of the residual solvent in the web on the occasion of the peeling from the metal support 20 was compensated by controlling the drying condition on the metal support 20 so that the residual solvent amount at the time of peeling off from the metal support 20 becomes to the same as that the other examples.

In Example 10, the fluctuation of viscosity (fluctuation of viscosity just before the casting) of the dope after dilution was 0.48% in the relative standard deviation which was within the range of the present invention.

(Inline-adding Liquid C)

| | | |
|---|---|---|
| Dope of Example 1 | 100 | parts by weight |
| Methylene chloride | 200 | parts by weight |
| Ethanol | 40 | parts by weight |

### Example 11

A cellulose acetate propionate film was prepared in the same manner as in Example 9 except that Inline-adding Liquid B was replaced with the following Inline-adding Liquid D.

The condition was set so that Inline-adding Liquid D should be added and the standard solid content was obtained when 2 parts by weight of Inline-adding Liquid D was added to 100 parts by weight of the dope.

The difference of the solid content of the dope after addition of the inline-adding liquid from those in Examples 1 through 10 was compensated by controlling the casting flow rate so that the film thickness was the same as that in the other examples, and the difference of the residual solvent in the web on the occasion of the peeling from the metal support 20 was compensated by controlling the drying condition on the metal support 20 so that the residual solvent amount at the time of peeling off from the metal support 20 becomes to the same as that the other examples.

In this case, the tube length of the static mixer was prolonged by 3 times of that in Examples 1 through 10 for improving the mixing state on the occasion of diluting the dope by the inline-adding liquid.

In Example 11, the fluctuation of viscosity (fluctuation of viscosity just before the casting) of the dope after dilution was 0.78% in the relative standard deviation which was within the range of the present invention.

(Inline-adding Liquid D)

| | | |
|---|---|---|
| Methylene chloride | 100 | parts by weight |
| Ethanol | 20 | parts by weight |

### Comparative Example 1 Through 4

For comparison, cellulose acetate propionate films were prepared in almost the same manner as in Example 9 except that Inline-adding Liquid B in Example 9 was not added.

### Example 12

A cellulose acetate propionate film was prepared in the same manner as in Example 1 except that the amount of cellulose acetate propionate powder for 1 batch was automatically controlled in an intermediate hopper equipped with a load cell, followed by feeding the powder to the dissolution vessel by compressed air.

In Comparative Examples 1 through 4, the cellulose acetate propionate to be charged was powder and the measuring accuracy of the powder was without the range of from −1 to +2% as shown in Table 1. The measuring accuracy was without the specified range of the present invention.

In Comparative Examples 1 through 4, on the occasion of beginning the charge of the materials of the film such as the cellulose acetate propionate, additives and solvents, the dope dissolved at the last time remains in the dissolution vessel 1 in an amount of from 1 to 3%, without the range of the present invention, of that of the dope to be prepared at this time according to the present invention as shown in Table 1.

In each of Comparative Examples 1, 3 and 4, the weight of the dope stood in the dope standing vessel or the storing amount in the standing vessels was 1.5 times of the amount of the initial dope to be newly dissolved. Such the condition was within the specified range by the present invention. In Comparative Example 2, the amount of the standing dope was 6.0 times of the amount of the newly dissolved initial dope; such the condition was without the present invention.

The difference of the solid content of the dope after addition of the inline-adding liquid from those in Examples 1 through 12 was compensated by controlling the casting flow rate so that the film thickness was the same as that in the other examples, and the difference of the residual solvent in the web on the occasion of the peeling from the metal support 20 was compensated by controlling the drying condition on the metal support 20 so that the residual solvent amount at the time of peeling off from the metal support 20 becomes to the same as that the other examples.

In each of Comparative Examples 1 through 4, the fluctuation of viscosity (fluctuation of viscosity just before the casting) of the dope after dilution was within the range of from 1.20 to 5.30% in the relative standard deviation which was without the range of the present invention.

(Measurement of Optical Slow Axis or Orientation Angle)

The cellulose acetate propionate films obtained in Examples 1 through 12 and Comparative Examples 1 through 4 were subjected for measurement of the optical slow axis or orientation angle for evaluating the properties thereof. Thus obtained results are shown in Table 1.

The orientation angle of the cellulose acetate propionate film was measured by KOBRA-21ADH, manufactured by Ooji Keisokuki Co., Ltd., at 9 points on a line in the width direction at 20 positions every 10,000 m. The maximum and the minimum values of the measured data were evaluated.

TABLE 1

| | | Remaining | | | | |
|---|---|---|---|---|---|---|
| | Resin powder | amount in | Storing amount | | | Orientation angle |
| | measuring | dissolution | in standing | | | fluctuation |
| | accuracy (%) | vessel (%) | vessel (times) | *1 | *2 | (degree) |
| Example 1 | 1.20 | 5 | 2.0 | 0.65 | 0.62 | −0.9 to +0.8 |
| Example 2 | 1.20 | 20 | 2.0 | 0.50 | 0.54 | −0.7 to +0.6 |
| Example 3 | 1.20 | 50 | 2.0 | 0.32 | 0.33 | −0.5 to +0.4 |
| Example 4 | 1.20 | 3 | 1.0 | 1.00 | 1.00 | −1.5 to +1.4 |
| Example 5 | 1.20 | 5 | 5.0 | 0.03 | 0.02 | −0.4 to +0.3 |
| Example 6 | −0.90 | 5 | 5.0 | 0.01 | 0.04 | −0.2 to +0.3 |
| Example 7 | 1.90 | 5 | 5.0 | 0.95 | 0.98 | −1.2 to +1.3 |
| Example 8 | 0.50 | 5 | 5.0 | 0.01 | 0.03 | −0.2 to +0.2 |
| Example 9 | 1.20 | 5 | 2.0 | 0.28 | 0.25 | −0.6 to +0.5 |
| Example 10 | 1.20 | 5 | 2.0 | 0.48 | 0.45 | −0.7 to +0.7 |
| Example 11 | 1.20 | 5 | 2.0 | 0.78 | 0.82 | −1.1 to +1.0 |
| Example 12 | 0.40 | 20 | 5 | 0.01 | 0.01 | −0.1 to +1.0 |
| Comparative Example 1 | 2.50 | 1 | 1.5 | 2.20 | 2.31 | −2.1 to +2.5 |
| Comparative Example 2 | 3.20 | 3 | 6.0 | 3.60 | 3.58 | −2.3 to +2.5 |
| Comparative Example 3 | −1.50 | 3 | 1.5 | 1.20 | 1.20 | −1.8 to +2.0 |
| Comparative Example 4 | 5.00 | 3 | 1.5 | 5.30 | 5.40 | −3.3 to +3.8 |

*1: Viscosity fluctuation of dope just before casting (%)
*2: Density fluctuation of dope just before casting (%)

It is cleared from the results shown in Table 1 that the viscosity fluctuation of the casting dope after dilution (viscosity fluctuation of dope just before casting) in each of Examples 1 through 12 according to the present invention was within the range of from 0.01 to 1 and the optical slow axis of each of the films prepared by such the dopes was perpendicular (the average orientation angle of the slow axis is 90°±1.5°) or parallel (the average orientation angle of the slow axis is 0°±1.5°).

As above-described, the cellulose acetate propionate film as an optical film excellent in the quality in which scattering of the optical slow axis or the orientation angle in the MD direction (film transport direction) was very small could be obtained by reducing the fluctuation of the viscosity and the solid content of the dope and that of the residual solvent amount on the occasion of the stretching. The cellulose acetate propionate film was useful for giving a suitable contrast property to the crystal liquid display as the retardation film for the liquid crystal display, particularly for the large screen liquid crystal display.

In the cellulose acetate propionate films of Comparative Example 1 through 4, the fluctuation of the orientation angle was made larger since the fluctuation of the viscosity of dope was large, and the contrast property of the liquid crystal display was deteriorated when the films were used as the retardation film.

What is claimed is:

1. A method of manufacturing an optical film using a solution casting method comprising the steps of:
(i) preparing an initial dope comprising a cellulose ester resin;
(ii) preparing a casting dope by diluting the initial dope with a diluting solution via inline dilution, the diluting solution having a solid content lower than a solid content of the initial dope; and
(iii) casting the casting dope on a metal support to form a cellulose ester film,
wherein
(a) an average orientation angle of the slow axis is 90°±1.5° or 0°±1.5° against a film transport direction of the cellulose ester film; and
(b) a fluctuation of a viscosity or a fluctuation of a density of the casting dope is controlled so that a relative standard deviation of the fluctuation of the viscosity or the fluctuation of the density of the casting dope is in the range of 0.01-1%.

2. The method of claim 1, wherein an amount of the diluting solution used for the inline dilution to the initial dope is automatically controlled by measuring the viscosity or the density of the initial dope before the inline dilution, and by calculating the amount of the diluting solution so that the relative standard deviation of the fluctuation of the viscosity or the fluctuation of the density of the casting dope is in the range of 0.01-1%.

3. The method of claim 1, wherein
(i-a) the initial dope is prepared by dissolving a film forming material including the cellulose ester resin in a solvent in a dissolution vessel; and
(i-b) a new batch of the dissolution of the film forming material is started while an initial dope prepared in a last batch remains in the dissolution vessel in an amount of 5-50% by weight of an amount of the new batch.

4. The method of claim 1, wherein the initial dope is prepared by dissolving a cellulose ester resin powder in a solvent and an amount of the cellulose ester resin powder is weighed with an accuracy of −1 to +2% based on a predetermined amount.

5. The method of claim 1 further comprising the steps of:
(i-1) still standing the initial dope prepared in the step (i), which is referred to as a first dope standing step;
(i-2) filtering the initial dope after the first dope standing step; and
(i-3) still standing the initial dope filtered in the step (i-2), which is referred to as a second dope standing step,
wherein each of amounts of the initial dope still stood in the first standing step and the second standing step is 1 to 5 times larger than an amount of a new batch of the initial dope.

6. An optical film manufactured by the method of claim 1.
